(19) United States
(12) Patent Application Publication
(10) Pub. No.: US 2016/0105088 A1
(43) Pub. Date: Apr. 14, 2016

(54) DC-EXCITED SYNCHRONOUS ELECTRIC MOTOR

(71) Applicant: Kenji NARITA, Yokohama-shi, Kanagawa (JP)

(72) Inventor: Kenji NARITA, Tokyo (JP)

(21) Appl. No.: 14/894,240

(22) PCT Filed: Jan. 22, 2014
(86) PCT No.: PCT/JP2014/051196

§ 371 Date: Nov. 25, 2015

(30) Foreign Application Priority Data
Jun. 4, 2013 (JP) 2013-117684
Jul. 31, 2013 (JP) 2013-159361

(51) Int. Cl. H02K 19/10; H02K 1/14; H02K 1/27

(52) U.S. Cl. CPC H02K 19/10; H02K 1/2706; H02K 1/2786; H02K 1/145

(57) ABSTRACT

In a DC-excited synchronous electric motor in which a field system is excited by using an exciting core, in order to obtain large torque density and output density, the effective area of air gaps, through which an armature and a field system face each other, is increased. The armature of a stator 300A (300B) is arranged to face a side surface in a radial direction and two side surfaces in an axial direction of the rotor 200A (200B), with air gaps, respectively. By supplying multiphase AC current from an inverter to the armature, rotating magnetic fields having the same polarity spatially and temporally are generated. Thereby, a torque and a rotation output in the same rotating direction are obtained in three air gaps G1 to G3.

### TECHNICAL FIELD

The present invention relates to a DC-excited synchronous electric motor. In more detail, the present invention relates to a DC-excited synchronous electric motor in which torque density and output density are increased by effectively using three air gap surfaces including one radial air gap surface and two axial air gap surfaces.

### BACKGROUND ART

As an example of an electric motor, a DC-excited synchronous electric motor is known. This type of electric motor includes an exciting coil and an exciting core for controlling rotation of a rotor. In general, power is supplied to the exciting coil via a slip ring. However, a slip ring has a disadvantage of low reliability because it is worn with a brush.

As such, a DC-excited synchronous electric motor, not using a slip ring, has been proposed. One example thereof is an electric motor described in Non-Patent Literature 1. As shown in FIG. 18, an electric motor 1A, described therein, includes a rotor 2A in which two field systems are fixed to a rotary shaft 21 as a combination of claw pole type, and an annular stator 3A arranged so as to face a side surface in a radial direction of the rotor 2A.

The rotor 2A is configured such that a portion of a side face (left side surface in FIG. 18) on the axial side of a field core 22 is notched, and in the notched portion 23, a free end side of an exciting core 4A, one end of which is supported by a support member not shown in a cantilever manner, is inserted to the inner side of the rotor 2A.

According to this configuration, by supplying a DC current to an exciting coil 41 of the exciting core 4A, the field systems of even poles of the claw pole are excited such that even-numbered poles become N pole and odd-numbered poles become S pole, for example, whereby a torque is generated between it and a rotating magnetic field of an armature on the stator 3A side.

As another example, an electric motor described in Non-Patent Literature 2 has been known. As shown in FIG. 19, an electric motor 1B, described therein, is one of inner rotor type having a disk-like rotor 2B and an annular stator 3B disposed along the outer peripheral surface in a radial direction of the rotor 2B.

As shown in FIG. 19(a), grooves are formed in a circumferential direction in a center portion of a field core 51 of the rotor 2B, whereby even-numbered teeth are formed on the right and left side, respectively. Further, between the teeth, a slot is formed in which the circumferential width is almost the same as the width of the tooth. The teeth and the slots are arranged to face each other in an alternating way on the right and left sides, and an N-pole permanent magnet is attached to the surface of the left-side slot, while an S-pole permanent magnet is attached to the surface of the right-side slot.

In the center portion of an armature core 32 of the stator 3B, a groove 34 is formed in a circumferential direction, and a ring-shaped exciting coil 41 is buried. When a DC current is supplied thereto, on the teeth to which permanent magnets 52 and 53 are not attached in the field system, a magnetic field having a polarity of N pole is generated on the teeth of the left-side field system, and a magnetic field having a polarity of S pole is generated on the teeth of the right-side field system. In the entire field system, a magnetic field of even-numbered poles is formed, and a torque is generated between it and the rotating magnetic field of the armature.

However, the two types of electric motors described above have the following problem. That is, in both cases, as an air gap surface is provided only in a radial direction, torque density and output density are low. In particular, the latter case has a structure such that formation of a magnetic field in the field system serving as a rotor is half shared by a permanent magnet and DC excitation. As such, a field magnetic flux by the DC excitation cannot be generated sufficiently.

The power (torque) of a motor is proportional to the sum total of motion direction components of attraction-repulsion (Maxwell stress) generated by the DC magnetic field by the field system and the AC magnetic field by the armature which act with each other via an air gap formed between them facing each other. This means that it is expressed as power (torque) of the motor ∞[magnitude of an AC magnetic flux of the armature]×[magnitude of a DC magnetic flux of the field system].

Based on an assumption that the size of the motor, electric loading, magnetic loading, an air gap length, and the like are almost constant, the following two expressions are established: [magnitude of an AC magnetic flux of the armature]∞[air gap area where the armature and the field system face each other], and [magnitude of a DC magnetic flux of the field system]∞[air gap area where the armature and the field system face each other]. As such, in order to increase the torque density and the output density of the motor, it is desirable to increase the air gap area where the armature and the field system face each other.

However, as the both are arranged to face each other with an air gap only in a radial direction or an axial direction, in order to increase the power output, it is necessary to further increase the air gap area of the stator and the rotor as described above.

### CITATION LIST

### Non-Patent Literature

Non-Patent Literature 1: INOUE Masaya, et al., “Elimination of Rare-Earths 2-Possibility of a Claw Pole Motor”, 2010 Annual Conference of the Institute of Electrical Engineers of Japan, Industry Applications Society (2-S8-3), II-pp.77 to 80
Non-Patent Literature 2: SAKAI Kazuto, “Principle and Basic Characteristics of a Hybrid Variable-Magnetic-Force Motor”, 2010 Annual Conference of the Institute of Electrical Engineers of Japan, Industry Applications Society (3-7), III-pp.149 to 154

### SUMMARY OF INVENTION

### Technical Problem

In view of the above, an object of the present invention is to increase the effective area of air gaps through which an armature and a field system face each other in a DC-excited synchronous electric motor in which the field system is excited using an exciting core, in order to obtain high torque density and output density.

### Solution to Problem

In order to solve the object described above, a first invention has the following characteristics. That is, in a DC-excited synchronous electric motor of an inner rotor type including a stator including an armature and a DC exciting core; and a rotor having a field system to be excited by the DC exciting core, the rotor being arranged on an inner peripheral surface side of the stator. The field system includes an even number of field magnetic poles made of a ferromagnetic material, the field magnetic poles being attached to a rotary shaft made of a ferromagnetic material via a support member made of a non-magnetic material in a state where the respective field magnetic poles are arranged at a predetermined interval in a circumferential direction of the rotor, each of the field magnetic poles having one radial surface on an outer diameter side and two axial surfaces on both surface sides along an axial direction of the rotary shaft. The armature includes an annular core, the annular core having armature teeth provided at a predetermined interval in a circumferential direction, each of the armature teeth having three tooth portions including a radial side tooth portion and axial side tooth portions that face the radial surface and the respective axial surfaces of the field magnetic pole via air gaps, respectively. The DC exciting core includes a first exciting core facing one of the respective axial surfaces of the field magnetic pole, and a second exciting core facing another one of the respective axial surfaces. An odd-numbered field magnetic pole of the field magnetic poles has a flux barrier portion that blocks a magnetic flux on one of the axial surfaces of a side facing the first exciting core, and has a flux gate portion that transmits a magnetic flux on another one of the axial surfaces of a side facing the second exciting core. An even-numbered field magnetic pole thereof has a flux gate portion that transmits a magnetic flux on one of the axial surfaces of a side facing the first exciting core, and has a flux barrier portion that blocks a magnetic flux on another one of the axial surfaces of a side facing the second exciting core. The DC exciting core includes a ring-shape DC exciting coil surrounding the rotary shaft, and a DC magnetic circuit is formed in which a magnetic flux, generated by supplying power, flows in the following sequence: an N pole side of the rotary shaft→the exciting core on the N pole side→a field magnetic pole having the flux gate portion of the odd-numbered or even-numbered field magnetic pole→air gaps of three surfaces→the annular core of the armature→the air gaps of the three surfaces→the even-numbered or odd-numbered field magnetic pole having the flux gate portion→the exciting core on an S pole side→an S pole side of the rotary shaft, whereby the even-numbered field magnetic pole and the odd-numbered field magnetic pole become different poles from each other. Rotating magnetic fields having the same polarity spatially and temporally are generated by supplying a multiphase AC current to the armature, and a rotation output is obtained by allowing a DC magnetic flux by the field system and an AC magnetic flux by the armature to act on each other in the air gaps on the three surfaces.

A second invention has the following characteristics. That is, in a DC-excited synchronous electric motor of an outer rotor type including a stator including an armature and a DC exciting core; and a rotor having a field system to be excited by the DC exciting core, the rotor being arranged on an outer peripheral surface side of the stator. The rotor includes a casing made of a non-magnetic material and rotatably supported by a fixing shaft made of a ferromagnetic material via a bearing member, and a field system attached to an inner peripheral surface side of the casing. The field system includes an even number of field magnetic poles made of a ferromagnetic material and arranged at a predetermined interval in a circumferential direction of the rotor, and each of the field magnetic poles includes a radial magnetic pole portion arranged on an inner peripheral surface of a circumferential side of the casing, and two axial magnetic pole portions arranged on inner peripheral surfaces of both sides along an axial direction of the fixing shaft of the casing. The armature includes an annular core made of a ferromagnetic material and fixed to the fixing shaft via a support member in which an inner peripheral side is made of a non-magnetic material, the annular core having armature teeth provided at a predetermined interval in a circumferential direction, each of the armature teeth having three tooth portions including a radial side tooth portion and axial side tooth portions that face the radial magnetic pole portion and the respective axial magnetic pole portions of the field magnetic pole via air gaps, respectively. The DC exciting core includes a first exciting core facing one of the respective axial magnetic pole portions of the field magnetic pole, and a second exciting core facing another one of the respective axial magnetic pole portions. An odd-numbered field magnetic pole of the field magnetic poles has a flux barrier portion that blocks a magnetic flux on one of the axial magnetic pole portions of a side facing the first exciting core, and has a flux gate portion that transmits a magnetic flux on another one of the axial magnetic pole portions of a side facing the second exciting core. An even-numbered field magnetic pole thereof has a flux gate portion that transmits a magnetic flux on one of the axial magnetic pole portions of a side facing the first exciting core, and has a flux barrier portion that blocks a magnetic flux on another one of the axial magnetic pole portions of a side facing the second exciting core. The DC exciting core includes a ring-shape DC exciting coil surrounding the rotary shaft, and a DC magnetic circuit is formed in which a magnetic flux, generated by supplying power, flows in the following sequence: an N pole side of the fixing→shaft the exciting core on the N pole side→a field magnetic pole having the flux gate portion of the odd-numbered or even-numbered field magnetic pole→air gaps of three surfaces→the annular core of the armature→the air gaps of the three surfaces→an even-numbered or odd-numbered field magnetic pole having the flux gate portion→the exciting core on an S pole side→an S pole side of the fixing shaft, whereby the even-numbered field magnetic pole and the odd-numbered field magnetic pole become different poles from each other. Rotating magnetic fields having the same polarity spatially and temporally are generated by supplying a multiphase AC current to the armature, and a rotation output is obtained by allowing a DC magnetic flux by the field system and an AC magnetic flux by the armature to act on each other in the air gaps of the three surfaces.

As a more preferable aspect, in the first and second inventions, it is preferable that the flux gate portion and the flux barrier portion are arranged on an inner diameter side of each of the field magnetic poles.

In the second invention, it is preferable that the armature includes an annular core having a square cross section, and on a surface of the annular core, a plurality of annular slots rotating around a center line of the core are formed in a circumferential direction at a predetermined interval, and that a toroidal winding armature coil for generating rotating magnetic fields, having the same polarity spatially and temporally, is applied in each of the slots.

In the second invention, it is preferable that the armature includes an annular core having a square cross section, the annular core is provided with slots, to which an armature coil is applied, along a circumferential direction at a predetermined interval, an armature tooth is formed between adjacent slots, the armature tooth including an outer diameter surface and both side surfaces of the annular core and being in a sectorial shape in which a circumferential width is increased gradually towards radially outside, and a concentrated winding armature coil is wound along respective peripheries of the outer diameter surface and the both side surfaces of the armature tooth in each of the slots, the concentrated winding armature coil generating rotating magnetic fields having the same polarity spatially and temporally.

### Advantageous Effect of Invention

According to the present invention, one radial air gap surface and two axial air gaps are provided between the stator side and the rotor side, and the polarities of the magnetic fields in the three air gaps are allowed to be the same polarity temporally and spatially in the armature, while the polarities are allowed to be the same polarity spatially in the field system. Thereby, a DC-excited synchronous electric motor in which torque density and output density are increased can be obtained.

### BRIEF DESCRIPTION OF DRAWINGS

FIG. 1 is a schematic sectional view showing a DC-excited synchronous electric motor of an inner rotor type according to a first embodiment of the present invention.

FIG. 2(a) is a left side view and FIG. 2(b) is a right side view of a rotor (field system) in the first embodiment.

FIG. 3 is a perspective view showing a field magnetic pole of the rotor of the first embodiment.

FIG. 4(a) is a central vertical sectional view of a stator (armature) and FIG. 4(b) is an A-A sectional view thereof, in the first embodiment.

FIG. 5 is a connection diagram showing a connecting state of an armature coil and a three-phase AC power supply in the first embodiment.

FIG. 6 is an explanatory diagram explaining a relative positional relation between a field magnetic pole and an exciting core and a flowing direction of a magnetic flux.

FIG. 7 is a sectional view of a main part showing a modification of a stator in the first embodiment.

FIG. 8 is a connection diagram showing a connecting state of an armature coil and a three-phase AC power supply in the modification.

FIG. 9 is a schematic sectional view showing a DC-excited synchronous electric motor of an outer rotor type according to a second embodiment of the present invention.

FIG. 10 is a perspective view showing a field magnetic pole of a rotor in the second embodiment.

FIG. 11(a) is a left side view and FIG. 11(b) is a right side view of the rotor in the second embodiment.

FIG. 12 is a side view of a stator in the second embodiment.

FIG. 13 is a connection diagram showing a connecting state between an armature coil and a three-phase AC power supply in the second embodiment.

FIG. 14(a) is a side view of a modification of a stator, FIG. 14(b) is a sectional view taken along a line B-B, and FIG. 14(c) is an explanatory diagram explaining a winding form of an armature coil, in the second embodiment.

FIG. 15 is a connection diagram showing a connecting state between an armature coil and a three-phase AC power supply in the modification.

FIG. 16 is a schematic diagram for explaining a flow of a DC excitation magnetic flux of an inner rotor type.

FIG. 17 is a schematic diagram for explaining a flow of a DC excitation magnetic flux of an outer rotor type.

FIG. 18 is schematic diagram showing a claw pole type electric motor as a first conventional example.

FIG. 19 is a schematic diagram showing a DC-excited synchronous electric motor as a second conventional example.

### DESCRIPTION OF EMBODIMENTS

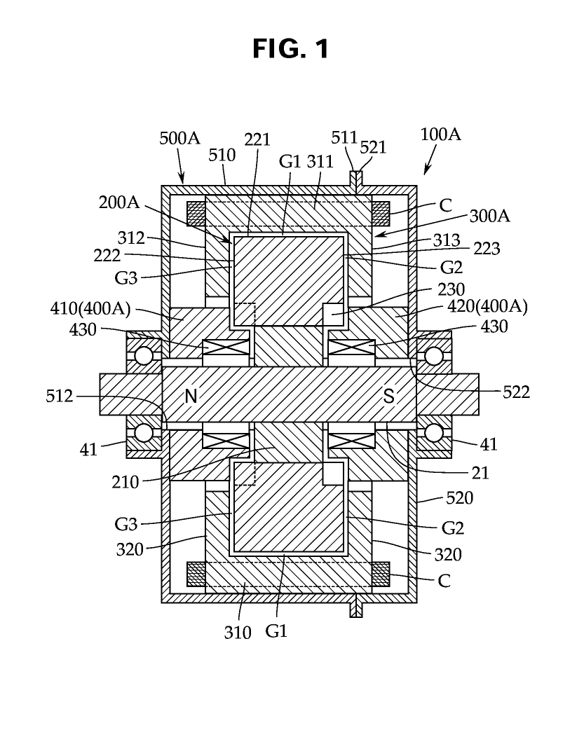

Next, some embodiments of the present invention will be described with reference to FIGS. 1 to 15. However, the present invention is not limited to these embodiments.

As shown in FIG. 1, a DC-excited synchronous electric motor 100A (hereinafter may be simply referred to as an electric motor 100A) according to a first embodiment is a DC-excited synchronous electric motor of an inner rotor type, including a rotary shaft 21 made of a ferromagnetic material, an annular rotor 200A having a field system which is mounted to the rotary shaft 21 coaxially, and a stator 300A having an exciting coil 430 and an exciting core 400A which excite the field system of the rotor 200A, arranged along the peripheral surface of the rotor 200A and having functions of an armature. The electric motor 100A is accommodated in a casing 500A having a cylindrical shape as a whole.

In the first embodiment, the casing 500A is divided into two parts along the axial line direction of the rotary shaft 21, including a cup-shaped casing body 510 and a lid member 520 mounted so as to close the opening of the casing body 510. The casing 500A is made of a non-magnetic material such as aluminum.

An attaching surface between the casing body 510 and the lid member 520 has flange portions 511 and 521. The casing 500A is formed by screwing the flange portions 511 and 521 in a state where the flange portions 511 and 521 abut against each other. It should be noted that they may be integrated by welding.

At the center in the axial line direction of the casing body 510 and the lid member 520, insertion holes 512, 522 are formed, and bearings 41 and 41 are coaxially arranged adjacent to the holes 512 and 522. In this embodiment, the bearings 41 and 41 are formed of radial ball bearings, in which the outer wheel side is supported by the casing 500 and the inner wheel side pivotally supports the rotary shaft 21.

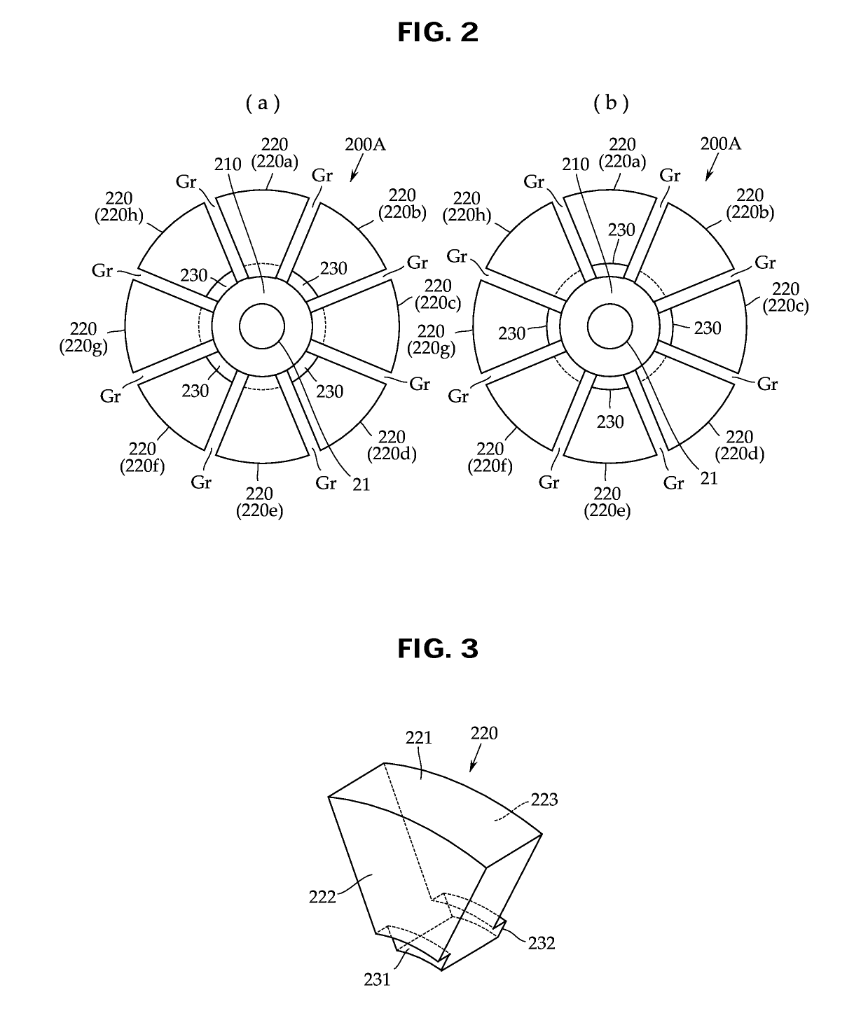

Also referring to FIG. 2, the rotor 200A includes a support member 210 in which the rotary shaft 21 is joined coaxially at the center, and a plurality of field magnetic poles 220 disposed along the outer peripheral surface of the support member 210.

The support member 210 has a circular pipe shape made of a non-magnetic material, and on the outer peripheral surface thereof, an even number of field magnetic poles 220 are fixed. As an exemplary method of fixing the field magnetic poles 220 on the support member 210, die casting, resin molding, or the like may be used.

Also referring to FIG. 3, the field magnetic pole 220 includes one radial tooth surface 221 and two axial tooth surfaces 222 and 223, and is formed to be in a sectorial columnar shape in which the circumferential width increases gradually from the center toward radially outside.

On one axial tooth surface 222 of the field magnetic pole 220, a flux barrier portion 231 may be provided for preventing a magnetic flux (flux), from the exciting core 400, from entering into the field magnetic pole 220.

In this embodiment, the flux barrier portion 231 is made of a dent dented from the outer peripheral surface to the inside of one axial tooth surface 222. A large air gap Gb formed by the dent functions as a large magnetic resistance so as to prevent a flux from entering into the field magnetic pole 220.

On the other axial tooth surface 223 of the field magnetic pole 220, a flux gate portion 232 is provided. The flux gate portion 232 has a structure of allowing a magnetic flux to go through easily by reducing the air gap Gg with the exciting core 400A to thereby reduce the magnetic resistance.

In this embodiment, the air gap space of the flux barrier portion 231 may be 3 mm or larger, and the air gap space of the flux gate portion 232 may be about 0.3 to 1 mm.

The flux barrier portion 231 and the flux gate portion 232 are arranged on the inner radial side of each field magnetic pole 220 (axial center side of the rotary shaft 21).

In this embodiment, the field magnetic poles 220 are provided for eight poles (220a to 220h). Between the respective field magnetic poles 220, an air gap Gr is provided as a flux barrier in order to prevent a flux from flowing between the respective field magnetic poles 220. The space of the air gap Gs may also be 3 mm or larger.

As shown in FIG. 2(a), on the left side surface of the stator 200A, the even-numbered field magnetic poles 220 (220b, 220d, 220f, and 220h), among the respective field magnetic poles 220, have the flux barrier portions 231, while the odd-numbered field magnetic poles 220 (220a, 220c, 220e, and 220g) have the flux gate portions 232.

Meanwhile, as shown in FIG. 2(b), on the right side surface of the stator 200A, the odd-numbered field magnetic poles 220 (220a, 220c, 220e, and 220g), among the respective field magnetic poles 220, have the flux barrier portions 231, while the even-numbered field magnetic poles 220 (220b, 220d, 220f, and 220h) have the flux gate portions 232.

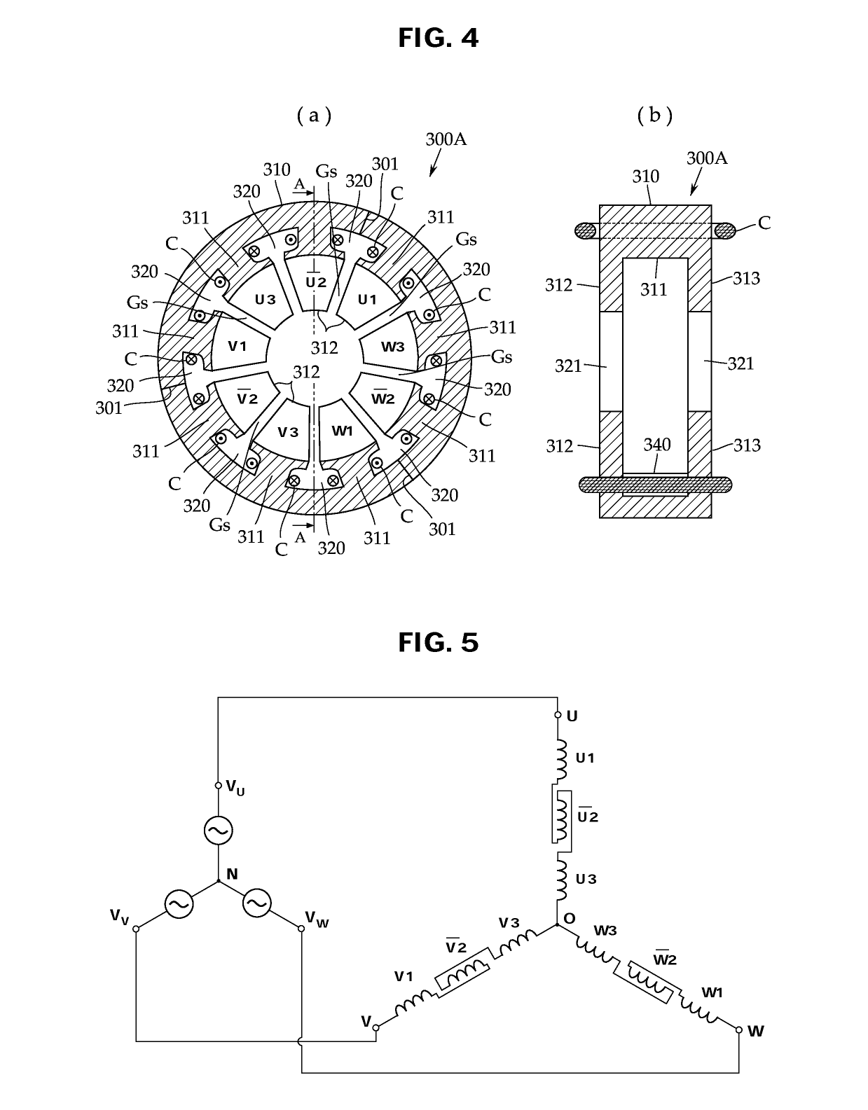

Next, also referring to FIG. 4, the stator 300A includes an annular core 310 as a yoke. The annular core 310 includes a radial tooth portion 311 facing the radial tooth surface 221 of the field magnetic pole 220 with a radial air gap G1 (surface in a vertical direction in FIG. 1), and two axial tooth portions 312 and 313 facing the axial tooth surfaces 222 and 223 of the rotor 2 with two axial air gaps G2 and G3 (surface in a lateral direction in FIG. 1). They are arranged in U shape (gate shape) so as to interpose the rotor 200A between them. It should be noted that the yoke has functions of three yokes of the radial tooth portion 311 and the two axial tooth portions 312 and 313.

The radial tooth portion 311 is protruded from the inner peripheral surface of the annular annular core 311 to the radial air gap G1 of the rotor 200A. The distal end thereof is cut off in an ark shape along the outer diameter of the rotor 200A. In this example, the radial tooth portions 311 are provided for nine slots. Each of the radial tooth portions 311 has a slot portion 320 around it, onto which an armature coil C is wound.

Each of the axial tooth portions 312 and 313 is formed in a sectorial shape in which the circumferential width decreases gradually from the proximal end side (radial tooth 310 side) toward the distal end side (rotary shaft 21 side). Between the respective axial tooth portions 312 and 313, an air gap Gs is provided as a flux barrier for preventing a magnetic flux from flowing between the axial tooth portions 32.

The distal end side of each of the axial tooth portions 320 is cut off in a semicircular shape, and an opening 321 for accommodating the exciting core 400A, described below, is provided on the inner diameter side thereof.

In this embodiment, a stator core 300A is formed of an annular layered body in which an axial portion, a radial portion, and an axial portion are layered and processed in an axial direction by press-processing electromagnetic steel plates. However, a sintered magnetic core or a powder magnetic core may be used, other than it.

As the radial tooth portion 311 and the two axial tooth portions 312 and 312 are integrally formed, in order to hold the rotor 200A inside the stator 300A, the stator 300A must be divided into two or more in a circumferential direction. As such, in this embodiment, the stator 300A is divided into three by division surfaces 301 along a radial direction at intervals of 120°.

While an armature coil C is wired in each slot portion 320, in the first embodiment, the armature coil C is wound as a concentrated winding coil along the periphery of the radial tooth portion 211.

FIG. 5 shows a connecting state between the three-phase AC power supply (Vu, Vv, and Vw) and the armature coil C. It should be noted that while, in FIG. 5, the coils with upper lines in the U phase, V phase, and W phase show that they are reversely wound relative to the coils without any upper lines, in the present description, reversely wound coils are shown with underlines as a matter of convenience.

By supplying a three-phase AC current (Vu, Vv, and Vw) from the three-phase AC power supply configured of inverters to the U phases (U1, U2, U3), the V phases (V1, V2, and V3), and W phases (W1, W2, and W3) of the three-phase concentrated winding armature coil, rotating magnetic fields having the same pole spatially and temporally are generated on the radial tooth portion 311 of the most outer diameter surface side and the axial tooth portions 312 and 313 on the both side surfaces. As such, a Maxwell stress acts between them and the field system of the rotor 200A side, whereby a rotary torque is generated in a given direction.

As the rotor 200A is arranged inside the stator 300A, the radial tooth surface 221 of the rotor 200A and the radial tooth portion 311 of the stator 300A face each other with the radial air gap G1, and the two axial tooth surfaces 222 and 223 of the rotor 200A and the axial tooth portions 312 and 313 of the stator 300A are arranged to face each other with the two axial air gaps G2 and G3, whereby three magnetically effective air gap surfaces G1 to G3 are formed.

Referring to FIG. 1 again, the exciting core 400A includes a first exciting core 410 arranged so as to face one axial tooth surface 221 (left side surface in FIG. 1) of the rotor 200A, and a second exciting core 420 arranged so as to face the other axial tooth surface 222 (right side surface in FIG. 1) of the rotor 200A.

The first exciting core 410 and the second exciting core 420 are coaxial annular cores around the rotary shaft 21, and a portion thereof is arranged so as to face the flux barrier portion 231 and the flux gate portion 232.

In each inner peripheral surface of the first exciting core 410 and the second exciting core 420, a ring-shaped exciting coil 430 is provided surrounding the rotary shaft 21. The respective exciting coils 430 are connected so as to have the same magnetization direction and formed to be a cored coil working as one exciting coil 430.

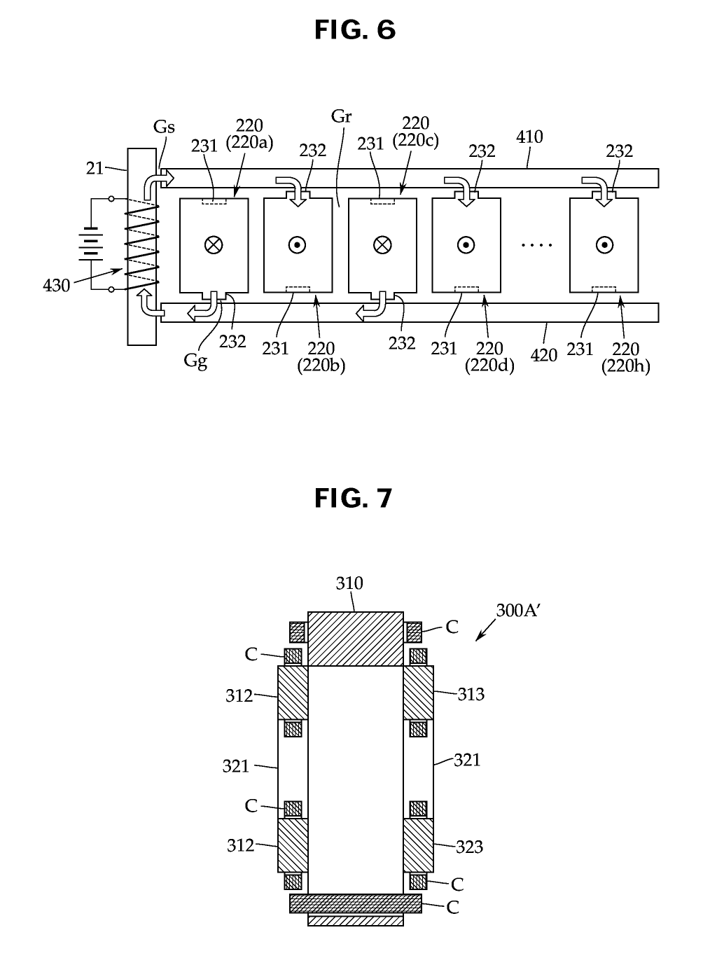

As shown in FIG. 6, by supplying a DC current to the exciting coil 430, the rotary shaft 21 becomes a magnet by the cored coil. As such, in the case where the first exciting coil 410 side has the N pole and the second exciting coil 420 side has the S pole as shown in FIG. 1, a DC magnetic circuit is formed in which the excitation magnetic flux (flux) flows in the following sequence: the N pole side of the rotary shaft 21→the air gap Gs between the rotary shaft 21 and the exciting core 410→the first exciting core 410→the air gap Gg between the exciting core 410 and the flux gate portion 232→the field magnetic poles (220b, 220d, 220f, and 220h) having the even-numbered flux gate portions 232→the air gaps G1 to G3 of the three faces→the annular core 311 of the armature 300A→the air gaps G1 to G3 of the three faces→the field magnetic poles (220a, 220c, 220e, and 220g) having odd-numbered flux gates 232→the air gap Gg between the exciting core 420 and the flux gate portion 232→odd-numbered flux gate portions 232→the second exciting core 420→the air gap Gs between the rotary shaft 21 and the exciting core 420→the S pole side of the rotary shaft 21.

It should be noted that regarding the air gaps G1 to G3 between the armature core and the field magnetic pole 220, the air gap Gs between the rotary shaft 21 and the exciting cores 410 and 420, and the air gap Gg between the flux gate portion 232 and the exciting cores 410 and 420, in order to reduce the magnetic resistance, the length between them is made shorter relatively. Meanwhile, regarding the air gap Gr between the field magnetic poles 220 and the air gap Gb between the field magnetic pole 220 and the exciting cores 410 and 420 without the flux gate portion 232, in order to increase the magnetic resistance, the length thereof is made longer relatively including the flux barrier portion 231.

According to this configuration, the direction of the magnetic flux flowing through the even-numbered field magnetic poles 220 (220b, 220d, 220f, and 220h) and the direction of the magnetic flux flowing through the odd-numbered field magnetic poles 220 (220a, 220c, 220e, and 220g) become opposite. Consequently, excitation is made such that the even-numbered field magnetic poles 220 (220b, 220d, 220f, and 220h) become N pole and the odd-numbered field magnetic poles 220 (220a, 220c, 220e, and 220g) become S pole, for example.

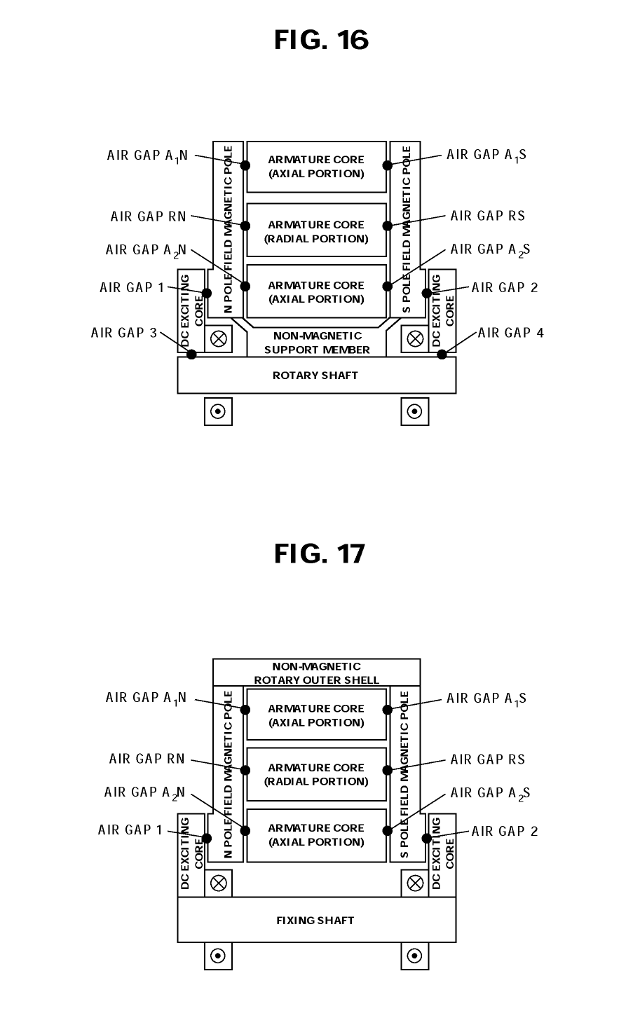

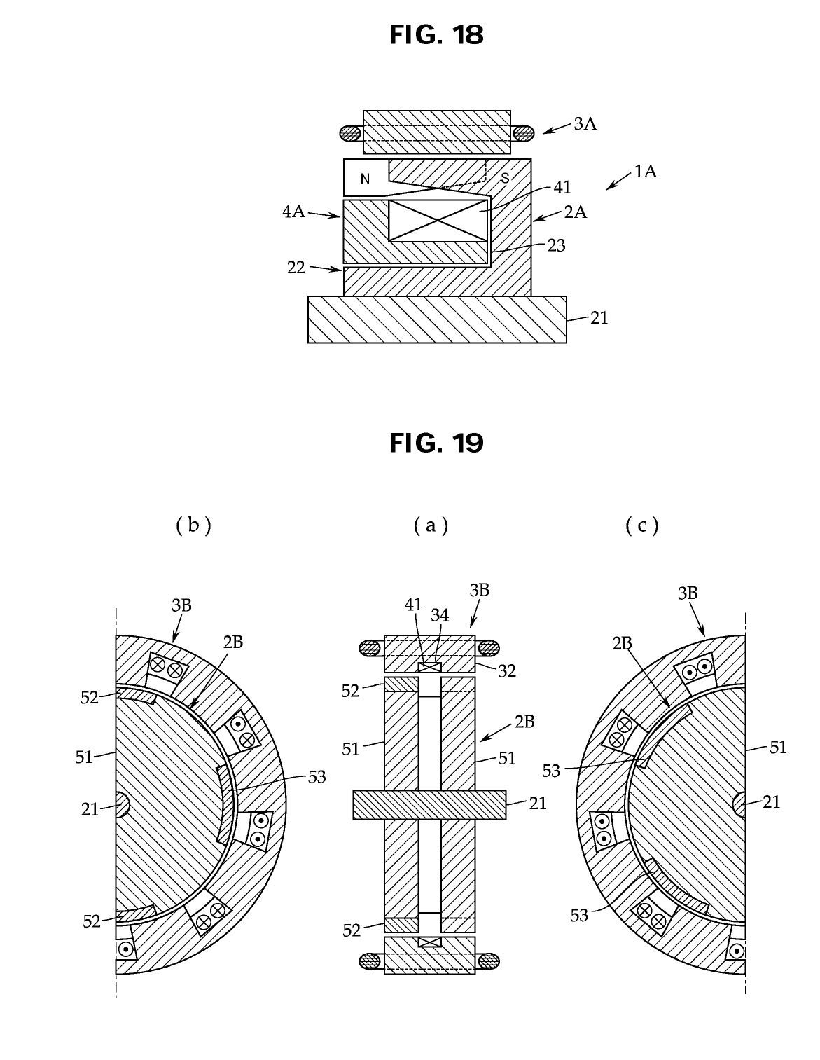

As shown in FIG. 16, the magnetic flux flowing from the N-pole field magnetic pole to the S-pole field magnetic pole is divided into three flows of the radial tooth portion 311 and the two axial tooth portions 312 and 313 of the annular core 310. Here, the magnetic permeability of the rotary shaft 21, the exciting core 400A, the field magnetic pole 220, and the armature core 310 is larger by three digits or more than the magnetic permeability of the air. As such, in the case of disregarding the magnetic resistance in these parts because it is small and only considering the air layer having a large magnetic resistance (that is, the air gap portions G1 to G3) and the air gap between the exciting core and the flux gate portion 231, the DC excitation magnetic flux is calculated according to Expression (1) shown below from the Ampere's law of circuital integration.

### [Expression 1]

$$2 NI = Φ ( \frac{2 c}{μ S 1} + \frac{2}{\frac{1}{\frac{g}{μ Sr / 2}} + \frac{2}{\frac{g}{μ Sa / 2}}} ) \qquad Expression ( 1 )$$

Here, the respective parameters in Expression (1) are as follows:

Φ: magnetic flux amount

I: DC current

Sa: areas of axial air gaps G2 and G3 (a half of the sum total of the facing area between the axial gap surfaces 222 and 223 of the field magnetic pole and the axial gap surfaces 312 and 313 of the armature core)

Sr: area of radial air gap (a half of the sum total of the facing area between the radial gap surface 221 of the field magnetic pole and the radial gap surface 311 of the armature core)

S1: facing area between the exciting core and the flux gate portion

N: the number of windings of one DC exciting coil

g: length of air gap

c: length of air gap

μ: magnetic permeability of the air

Next, referring to FIG. 7, a modification of the stator 300A of the first embodiment will be described, in which parts which are identical to or which are deemed to be identical to those in the embodiment described above are denoted by the same reference signs. A stator 300A′ in the modification is configured such that a radial tooth portion 310 and two axial tooth portions 312 and 313 are formed independent from each other and are arranged in U shape (gate shape) so as to interpose the rotor 200A between them.

Nine pieces of radial tooth portions 311 are arranged concentrically with respect to the outer peripheral surface of the rotor 200A. The radial tooth portion 311 is formed such that an armature coil C is wound around an annular annular core. The basic structure is the same as that of the radial tooth portion 311 of the stator 300A described above.

Each of the axial tooth portions 312 and 313 is formed to be in a sectorial shape in which the circumferential width is increased gradually from the center toward radially outside. In this example, a plurality of them, specifically nine pieces, are arranged in a circumferential direction annularly. On the axial tooth portion 320, the armature coil C is wound.

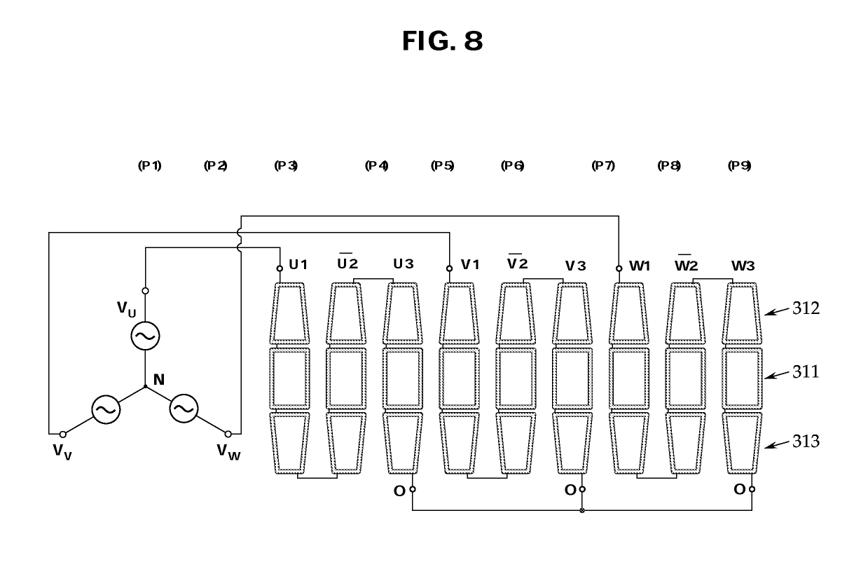

By applying three phase AC connection to the radial tooth portion 311 and the two axial tooth portions 312 and 313 as shown in FIG. 8 and supplying three-phase alternating current thereto, rotating magnetic fields having the same polarity spatially and temporally are generated in the radial tooth portion 311 on the most outer diameter surface side and the axial tooth portions 312 and 313 of the both side surfaces. As such, a Maxwell stress acts between it and the field system of the rotor 200A side, whereby a rotary torque and output are generated in a given direction.

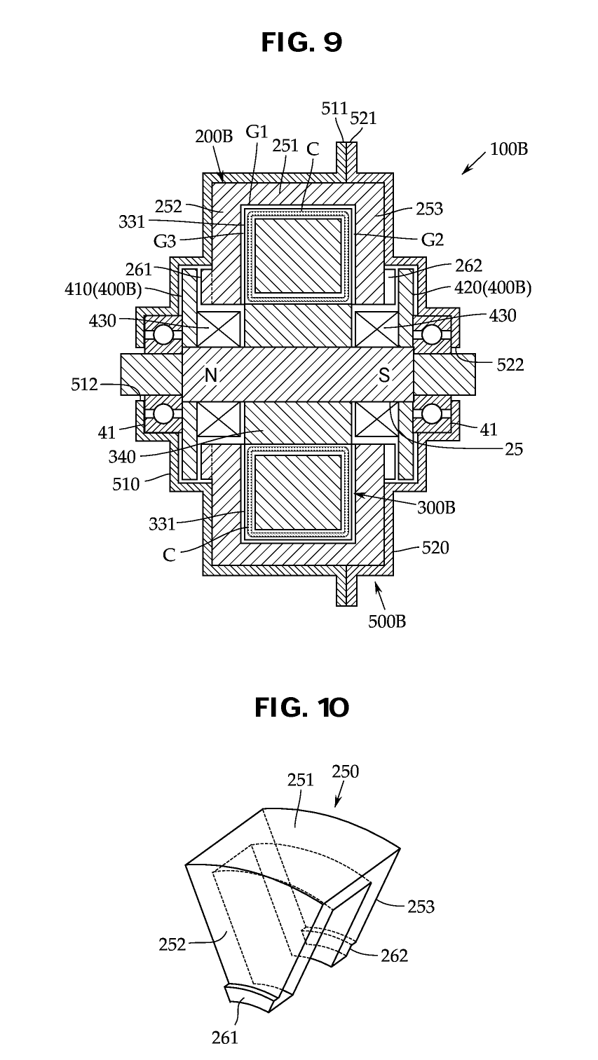

Next, a DC-excited synchronous electric motor of an outer rotor type according to a second embodiment will be described with reference to FIGS. 9 to 15.

As shown in FIG. 9, a DC-excited synchronous electric motor 100B (hereinafter may be simply referred to as an electric motor 100B) of the second embodiment is a DC-excited synchronous electric motor of an outer rotor type, including, a fixing shaft 25 made of a ferromagnetic material, a stator 300B fixed to the fixing shaft 25, a rotor 200B having a field system on the inside surface of a casing 500B rotatably supported by the fixing shaft 25 via bearing members 41 and 41, and an exciting core 400B on which an exciting coil 430 which excites the field system is wound. The rotor 200B is disposed on the outer peripheral surface side of the stator 300B.

In the second embodiment, the casing 500B is divided into two parts along the axial line direction of the fixing shaft 25 to which the stator 300B is fixed. One of them, that is, a first casing 510 (casing body) is formed to be in a cup shape, and has an insertion hole 511 in the center portion thereof through which the fixing shaft 25 is inserted. As the casing 500B, a non-magnetic material such as aluminum is used, for example.

The other one of them, that is, a second casing 520 (lid member) is formed as a lid member for closing the opening of the first casing 41, and has an insertion hole 521 in the center portion thereof through which a fixing shaft 23 is inserted being formed.

On the opening sides of the first casing 510 and the second casing 520, flange portions 512 and 522 are formed. By screwing, with screws not shown for example, the flange portions 412 and 422 in a state where the flange portions abut against each other, the casings 510 and 520 are firmly linked to each other. The first casing 510 and the second casing 520 may be joined by welding.

The casing 500B has radial bearings 41 and 41 in the portions of the insertion holes 511 and 521, and the fixing shaft 25 is supported by the casing 500B via the radial bearings 41 and 41.

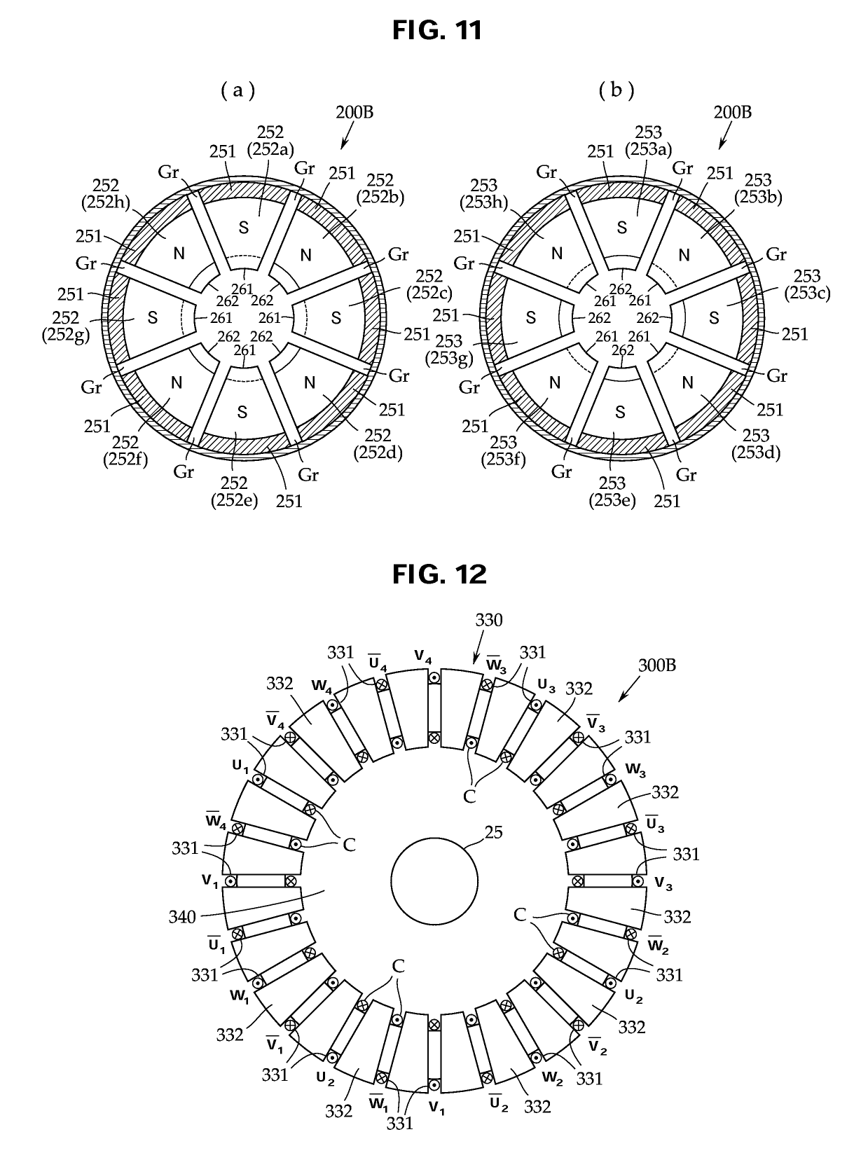

Referring to FIG. 10 and FIG. 11 together, the rotor 200B includes a field magnetic pole 250 having a radial tooth portion 251 arranged so as to face the radial surface of the stator 300B with a radial air gap G1, and two axial tooth portions 252 and 253 arranged so as to face the two axial surfaces of the stator 300B with radial air gaps G2 and G3.

While the field magnetic pole 250 is made of one in which ferromagnetic materials, such as electromagnetic steel sheets for example, are layered along the axial line direction, it is possible to use a sintered magnetic core or a powder magnetic core, other than it. Between the respective field magnetic poles 250, an air gap Gr is formed as a flux barrier for preventing a magnetic flux from flowing between the field magnetic poles 250.

In the second embodiment, the field magnetic pole 250 is formed to have a U-shaped cross section in which the axial tooth portions 252 and 253 are integrally extended in a right angle direction from the both ends of the radial tooth portion 251. The axial tooth portions 252 and 253 are formed to be in a sectorial shape in which the circumferential width is decreased gradually from the proximal end side (radial field magnetic pole 251 side) toward the free end side (fixing shaft 25 side).

One of the two axial tooth portions 252 and 253, namely the axial tooth portion 252 (left side in FIG. 10), has a flux gate portion 261 having a function of reducing the magnetic resistance by having a small air gap between the exciting cores 410 and 420 and the field core 220 in order to facilitate introduction of a magnetic flux from the exciting cores 410 and 420 to the field magnetic pole 220. The flux gate portion 261 is formed of a protrusion protruding from the tooth surface of the axial tooth portion 252. It should be noted that the axial tooth 252 may be a simple flat plane.

On the other hand, the other one, namely the axial tooth portion 253 (right side in FIG. 10), has a flux barrier portion 262 having a function of increasing the magnetic resistance by having a large air gap between the exciting cores 410 and 420 and the field magnetic pole 220 in order not to facilitate introduction of a magnetic flux of the exciting core 400B to the field magnetic pole 250. It should be noted that the axial tooth portion 253 may be a simple flat plane.

In contrast to the flux gate portion 261, the flux barrier portion 262 is formed of a dent dented from the axial tooth portion 253 in a direction away from the exciting core 500B (inside). By increasing the air gap distance between the flux barrier portion 262 and the exciting core 500B, it is possible to prevent the flux from entering the flux barrier portion 262. Even in the second embodiment, the flux gate portion 261 and the flux barrier portion 262 are arranged on the inner diameter side (axial center side of the fixing shaft 25) of the axial tooth portions 252 and 253 respectively.

As shown in FIG. 11(a), in the second embodiment, on the left side surface of the rotor 200B, the odd-numbered axial tooth portions 252 (252a, 252c, 252e, and 252g) of the axial tooth portions 252 are provided with the flux gate portions 261, and the even-numbered axial tooth portions 252 (252b, 252d, 252f, and 252h) are provided with the flux barrier portions 262.

On the other hand, as shown in FIG. 11(b), on the right side surface of the rotor 200B, the even-numbered axial tooth portion 253 (253b, 253d, 253f, and 253h) of the axial tooth portions 253 are provided with the flux gate portions 261, and the odd-numbered axial tooth portions 253 (253a, 253c, 253e, and 253g) are provided with the flux barrier portions 262.

There are three possible combinations of the flux gate portion 231 (261) and the flux barrier portion 232 (262), as shown in the following Table 1.

TABLE 1

| | One axial surface | | The other axial surface | |
|---|---|---|---|---|
| | | Odd- | | Odd- |
| | Even-numbered | numbered | Even-numbered | numbered |
| | field | field | field | field |
| | magnetic | magnetic | magnetic | magnetic |
| | pole | pole | pole | pole |
| 1st method | Protrusion | Dent | Dent | Protrusion |
| 2nd method | Protrusion | Flat | Flat | Protrusion |
| 3rd method | Flat | Dent | Dent | Flat |

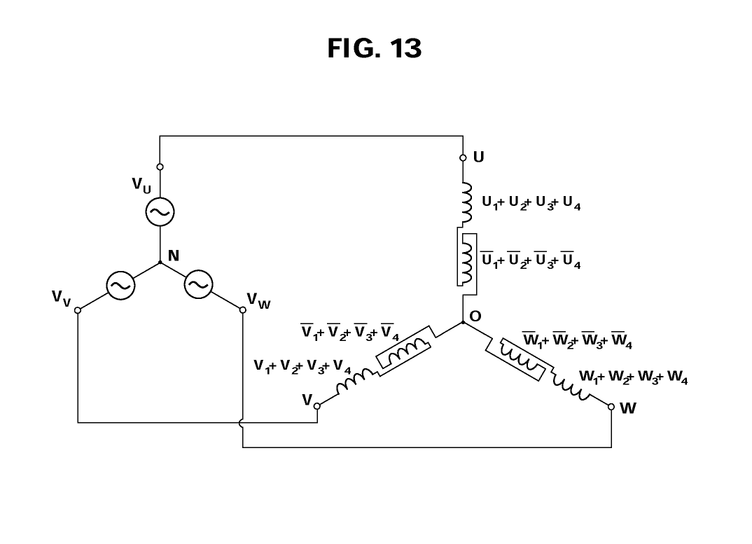

Referring to FIG. 12 and FIG. 13, the stator 300B includes an annular core 330 as an armature, and the annular core 330 is fixed to the fixing shaft 25 via a support member 340 made of a non-magnetic material such as an aluminum material, synthetic resin material, or the like.

The annular core 330 is formed such that a plurality of electromagnetic steel sheets for example, blanked into a disk shape, are layered along the axial line direction (lateral direction in FIG. 9). The cross section along the radial direction in a layered state has a square shape. In order to make winding easy, it may be divided into plural in a circumferential direction. The annular core 330 may be a powder magnetic core or a sintered magnetic core, rather than the electromagnetic steel sheet layered core.

In the second embodiment, the annular core 330 has a slot (groove) 331 for winding the armature coil C. The slot 331 is formed to be in an annular shape so as to rotate the center line of the annular core 330. This means that the slot 331 is continuously formed on the same radius line on the outer diameter surface, both side surfaces, and the inner diameter surface of the annular core 21.

The slots 331 are arranged at predetermined intervals along a circumferential direction of the annular core 330, and the armature coil C is wound on each of them as a toroidal coil. The electric motor 100B according to the second embodiment is a three-phase eight-pole motor, and the slots 331 are arranged at twenty four locations at 15° intervals. An iron core portion between adjacent slots 331 and 331 acts as an armature tooth 332.

The connection diagram of FIG. 13 shows a connecting state between the three-phase eight-pole toroidal coil in FIG. 12 and a three-phase AC power supply (Vu, Vv, and Vw). It should be noted that in FIG. 12 and FIG. 13, while the coils with upper lines in the U phase, V phase, and W phase show that they are reversely wound relative to the coils without any upper lines, in the present description, reversely wound coils are shown with underlines as a matter of convenience.

With respect to U phases (U1+U2+U3+U4, U1+U2+U3+U4), the V phases (V1+V2+V3+V4, V1+V2+V3+V4), and W phases (W1+W2+W3+W4, W1+W2+W3+W4) of the toroidal coil, by supplying three-phase alternating current (Vu, Vv, and Vw) from the three-phase AC power supply configured of inverters, rotating magnetic fields having the same polarity spatially and temporally are generated on the radial portion of the most outer diameter surface side and the axial portions on the both side surfaces, in the annular core 330. As such, a Maxwell stress acts between it and the field system of the rotor 200B side, whereby a rotary torque is generated in a given direction.

Referring to FIG. 9 again, the exciting core 400B includes the first exciting core 410 arranged so as to face the axial tooth surface 252 of the rotor 200B (left side surface in FIG. 9), and the second exciting core 420 arranged so as to face the axial tooth surface 253 of the stator 300B (right side face of FIG. 1).

The first exciting core 410 and the second exciting core 420 are coaxial annular cores around the rotary shaft 21, and are pressed in and fixed to the outer peripheral surface of the fixing shaft 25. In the first exciting core 410 and the second exciting core 42, the exciting coils 430 are wound about the fixing shaft 23. The respective exciting coils 430 are connected with each other and function as one exciting coil 430 which is a cored coil for exciting the fixing shaft 25.

By supplying DC current to the exciting coil 430, the fixing shaft 25 which is a cored coil becomes a magnet. As such, in the case where the first exciting coil 410 side has the N pole and the second exciting coil side 420 has the S pole as shown in FIG. 9, a DC magnetic circuit is formed in which the magnetic flux flows in the following sequence: N pole side of the fixing shaft 25→the first exciting core 410→the even-numbered field magnetic poles (252b, 252d, 252f, and 252h) having the flux gate portion 261→the air gaps G1 to G3 of the three surfaces→the annular core 311 of the armature 300B→the air gaps G1 to G3 of the three surfaces→the odd-numbered field magnetic poles (253a, 253c, 253e, and 253g) having the flux gate portion 261→the second exciting core 420→S pole side of the fixing shaft 25. The even-numbered field magnetic poles and odd-numbered field magnetic poles become opposite poles.

Consequently, the directions of the magnetic fields of the even-numbered field magnetic pole and the odd-numbered field magnetic poles become opposite, and excitation is made such that the odd-numbered field magnetic poles 252 and 253 (252a, 252c, 252e, and 252g (253a, 253c, 253e, and 253g)) become S pole and the even-numbered field magnetic poles 252 and 253 (252b, 252d, 252f, and 252h (253b, 253d, 253f, and 253h)) become N pole.

As shown in FIG. 17, the magnetic flux flowing from the N-pole field magnetic pole to the S-pole field magnetic pole are divided into three flows of a radial portion and two axial portions of the armature core 330. The magnetic permeability of the rotary shaft 21, the exciting core 400B, the field magnetic pole 220, and the armature core 310 is larger by three digits or more than the magnetic permeability of the air. As such, in the case of disregarding the magnetic resistance in these parts because it is small and only considering the air layer having a large magnetic resistance (that is, air gap portions G1 to G3) and the air gap between the exciting core and the flux gate portion 231, the DC excitation magnetic flux is calculated according to Expression (2) shown below, from the Ampere's law of circuital integration.

$$\begin{matrix}[ Expression 2 ] & \\ 2 NI = φ ( \frac{2 c}{μ S 1} + \frac{2 c}{μ S 2} + \frac{2}{\frac{1}{\frac{g}{μ Sr / 2}} + \frac{2}{\frac{g}{μ Sa / 2}}} ) & Expression ( 2 )\end{matrix}$$

Here, the respective parameters in Expression (2) are as follows:

Φ: magnetic flux amount

I: DC current

Sa: area of axial air gap G2, G3 (a half of the sum total of the facing area between the field magnetic pole and the armature core in one axial air gap)

Sr: area of radial air gap (a half of the sum total of the facing area between the field magnetic pole and the armature core in the radial air gap)

S1: area of the exciting core and the flux gate portion

S2: area of the exciting core and the rotary shaft

N: the number of windings of one DC exciting coil

g: length of air gap

c: length of air gap

μ: magnetic permeability of the air

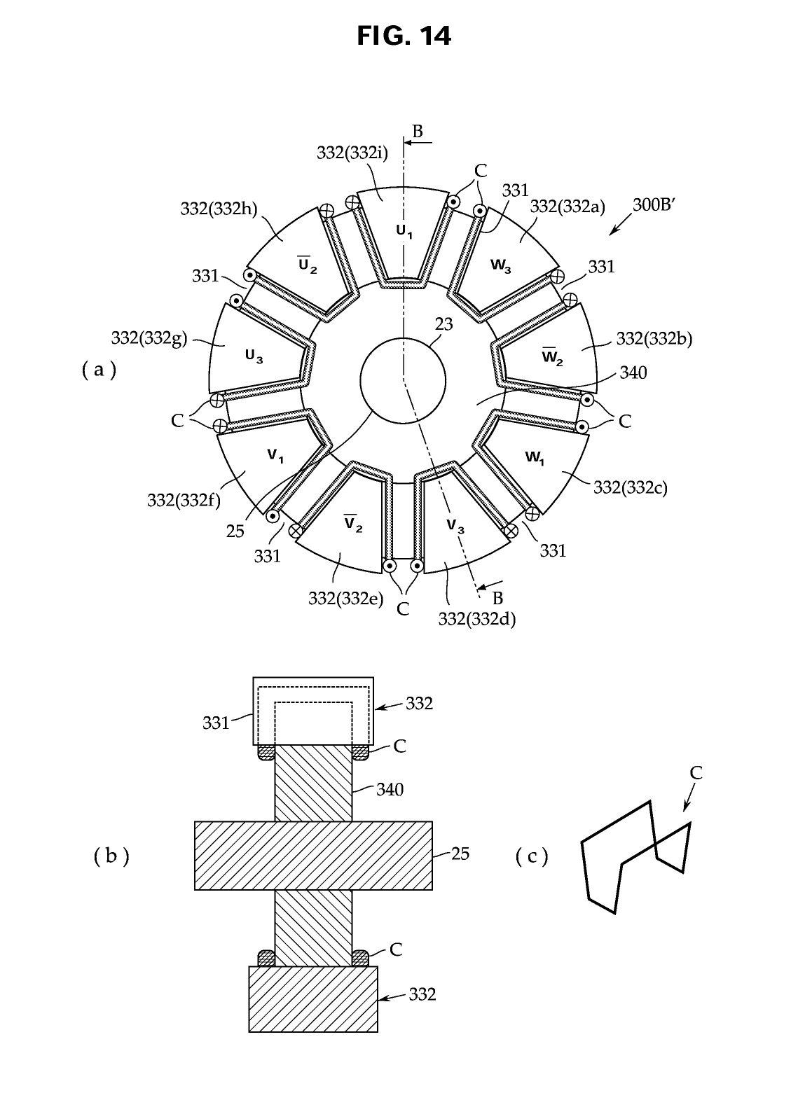

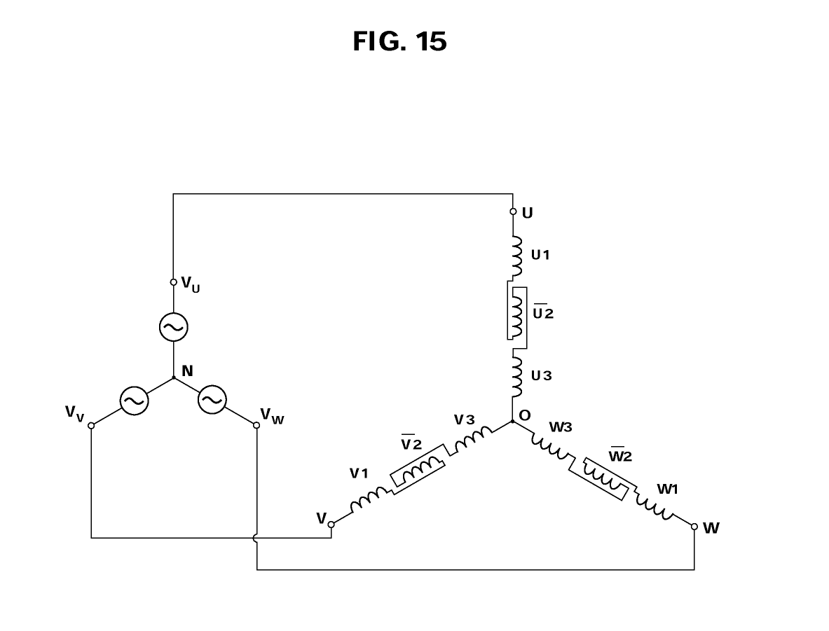

Next, referring to FIGS. 14 and 15, a modification of a stator of a permanent magnet type synchronous electric motor 100B according to the second embodiment will be described.

In this modification, a stator 300B′ having the configuration shown in FIG. 14 is included. In the stator 300B′, elements which are identical to or which can be deemed to be identical to those in the stator 300B of the second embodiment are denoted by the same reference signs.

The stator 300B′ has an iron core 330 having a square cross section formed in an annular shape. The annular core 330 is fixed to the fixing shaft 25 via the support member 340 made of a non-magnetic material, as in the first embodiment.

It should be noted that the annular core 330 may be fixed directly to the fixing shaft 25. Further, the support member 340 may be made of a magnetic material. Further, as the annular core 330, an electromagnetic steel sheet layered iron core, a powder magnetic core, a sintered magnetic core, or the like may be used.

The stator 300B′ has three phase nine slots, and is capable of making a three-phase eight-pole rotating magnetic field. In the annular core 330, nine pieces of armature teeth 332 (332a to 332i) are provided at intervals of 40°.

In this embodiment, in order to have effective rotary torques in three gap surfaces including a radial gap surface and two axial gap surfaces between the armature teeth 332 and the field on the rotor 200B side, the armature teeth 332 (332a to 32i) are formed such that the armature teeth 331 are in a saddle shape and a concentrated winding armature coil C is applied to each of the armature teeth 332a to 332i.

In the annular core 330, slots 331 to which the armature coil C is applied are arranged along a circumferential direction with predetermined intervals (in this example, the number of slots is nine).

While the part between the adjacent slots 331 becomes the armature tooth 332, in this modification, the armature tooth 332 is formed in a saddle shape (solid trapezoid sectorial shape) which includes three surfaces, namely an outer diameter surface and both side surfaces of the annular core 330 (one surface on the radial side and two surfaces on the axial side) and in which the circumferential width is increased gradually toward radially outside. This means that the armature tooth 332 includes one radial tooth portion and two axial tooth portions.

While the armature coil C is wired in the slot 331, in this modification, the armature coil C is wound as three-dimensional concentrated winding along each periphery of the outer diameter surface (radial tooth portion) and both side surfaces (axial tooth portions) of the armature tooth 220, as shown in FIG. 14(c).

The connection diagram of FIG. 15 shows a connecting state of the three-phase concentrated winding armature coil in FIG. 14 and the three-phase AC power supply (Vu, Vv, and Vw). It should be noted that in FIG. 14 and FIG. 15, while the coils with upper lines in the U phase, V phase, and W phase show that they are reversely wound relative to the coils without any upper lines, in the present description, reversely wound coils are shown with underlines as a matter of convenience.

With respect to the U phases (U1, U2, U3), the V phases (V1, V2, and V3), and W phases (W1, W2, and W3) of the three-phase concentrated winding armature coil, by supplying three-phase alternating current (Vu, Vv, and Vw) from the three-phase AC power supply configured of inverters, in the annular core 21, rotating magnetic fields having the same pole spatially and temporally are generated on the radial tooth portion of the most outer diameter surface side and the axial tooth portions on the both side surfaces. As such, a Maxwell stress acts between it and the field system of the rotor 3B, whereby a rotary torque is generated in a given direction.

### REFERENCE SIGNS LIST

100A DC-excited synchronous electric motor (inner rotor type)
100B DC-excited synchronous electric motor (outer rotor type)
200A rotor (inner rotor type)
200B rotor (outer rotor type)
210 support member
220 field magnetic pole
231, 261 flux barrier portion
232, 262 flux gate portion
250 field magnetic pole
251 radial tooth portion
252, 253 axial tooth portion
300A stator (inner rotor type)
300B stator (outer rotor type)
310 annular core
311 radial tooth portion
312 axial tooth portion
320 support member
400A exciting core (inner rotor type)
400B exciting core (outer rotor type)
410 first exciting core
420 second exciting core
430 exciting coil
G1 radial air gap
G2, G3 axial air gap

1. A DC-excited synchronous electric motor of an inner rotor type, comprising:
a stator including an armature and a DC exciting core; and
a rotor having a field system to be excited by the DC exciting core, the rotor being arranged on an inner peripheral surface side of the stator, wherein
the field system includes an even number of field magnetic poles made of a ferromagnetic material, the field magnetic poles being attached to a rotary shaft made of a ferromagnetic material via a support member made of a non-magnetic material in a state where the respective field magnetic poles are arranged at a predetermined interval in a circumferential direction of the rotor, each of the field magnetic poles having one radial surface on an outer diameter side and two axial surfaces on both surface sides along an axial direction of the rotary shaft,
the armature includes an annular core, the annular core having armature teeth provided at a predetermined interval in a circumferential direction, each of the armature teeth having three tooth portions including a radial side tooth portion and axial side tooth portions that face the radial surface and the respective axial surfaces of the field magnetic pole via air gaps, respectively,
the DC exciting core includes a first exciting core facing one of the respective axial surfaces of the field magnetic pole, and a second exciting core facing another one of the respective axial surfaces,
an odd-numbered field magnetic pole of the field magnetic poles has a flux barrier portion that blocks a magnetic flux on one of the axial surfaces of a side facing the first exciting core, and has a flux gate portion that transmits a magnetic flux on another one of the axial surfaces of a side facing the second exciting core,
an even-numbered field magnetic pole has a flux gate portion that transmits a magnetic flux on one of the axial surfaces of a side facing the first exciting core, and has a flux barrier portion that blocks a magnetic flux on another one of the axial surfaces of a side facing the second exciting core,
the DC exciting core includes a ring-shape DC exciting coil surrounding the rotary shaft, and a DC magnetic circuit is formed in which a magnetic flux, generated by supplying power, flows in a following sequence: an N pole side of the rotary shaft→the exciting core on the N pole side→a field magnetic pole having the flux gate portion of the odd-numbered or even-numbered field magnetic pole→air gaps of three surfaces→the annular core of the armature→the air gaps of the three surfaces→the even-numbered or odd-numbered field magnetic pole having the flux gate portion→the exciting core on an S pole side→an S pole side of the rotary shaft, and the even-numbered field magnetic pole and the odd-numbered field magnetic pole become different poles from each other, and
rotating magnetic fields having a same polarity spatially and temporally are generated by supplying a multiphase AC current to the armature, and a rotation output is obtained by allowing a DC magnetic flux by the field system and an AC magnetic flux by the armature to act on each other in the air gaps on the three surfaces.

2. A DC-excited synchronous electric motor of an outer rotor type, comprising:
a stator including an armature and a DC exciting core; and
a rotor having a field system to be excited by the DC exciting core, the rotor being arranged on an outer peripheral surface side of the stator, wherein
the rotor includes a casing made of a non-magnetic material and rotatably supported by a fixing shaft made of a ferromagnetic material via a bearing member, and a field system attached to an inner peripheral surface side of the casing,
the field system includes an even number of field magnetic poles made of a ferromagnetic material and arranged at a predetermined interval in a circumferential direction of the rotor, and each of the field magnetic poles includes a radial magnetic pole portion arranged on an inner peripheral surface of a circumferential side of the casing, and two axial magnetic pole portions arranged on inner peripheral surfaces of both sides along an axial direction of the fixing shaft of the casing,
the armature includes an annular core made of a ferromagnetic material and fixed to the fixing shaft via a support member in which an inner peripheral side is made of a non-magnetic material, the annular core having armature teeth provided at a predetermined interval in a circumferential direction, each of the armature teeth having three tooth portions including a radial side tooth portion and axial side tooth portions that face the radial magnetic pole portion and the respective axial magnetic pole portions of the field magnetic pole via air gaps, respectively,
the DC exciting core includes a first exciting core facing one of the respective axial magnetic pole sections of the field magnetic pole, and a second exciting core facing another one of the respective axial magnetic pole,
an odd-numbered field magnetic pole of the field magnetic poles has a flux barrier portion that blocks a magnetic flux on one of the axial magnetic pole portions of a side facing the first exciting core, and has a flux gate portion that transmits a magnetic flux on another one of the axial magnetic pole portions of a side facing the second exciting core,
an even-numbered field magnetic pole has a flux gate portion that transmits a magnetic flux on one of the axial magnetic pole portions of a side facing the first exciting core, and has a flux barrier portion that blocks a magnetic flux on another one of the axial magnetic pole portions of a side facing the second exciting core,
the DC exciting core includes a ring-shape DC exciting coil surrounding the rotary shaft, and a DC magnetic circuit is formed in which a magnetic flux, generated by supplying power, flows in a following sequence: an N pole side of the fixing shaft→the exciting core on the N pole side→a field magnetic pole having the flux gate portion of the odd-numbered or even-numbered field magnetic pole→air gaps of three surfaces→the annular core of the armature→the air gaps of the three surfaces→an even-numbered or odd-numbered field magnetic pole having the flux gate portion→the exciting core on an S pole side→an S pole side of the fixing shaft, and the even-numbered field magnetic pole and the odd-numbered field magnetic pole become different poles from each other, and
rotating magnetic fields having a same polarity spatially and temporally are generated by supplying a multiphase AC current to the armature, and a rotation output is obtained by allowing a DC magnetic flux by the field system and an AC magnetic flux by the armature to act on each other in the air gaps of the three surfaces.

3. The DC-excited synchronous electric motor according to claim 1, wherein
the flux gate portion and the flux barrier portion are arranged on an inner diameter side of each of the field magnetic poles.

4. The DC-excited synchronous electric motor according to claim 2, wherein
the armature includes an annular core having a square cross section, and on a surface of the annular core, a plurality of annular slots rotating around a center line of the core are formed in a circumferential direction at a predetermined interval, and a toroidal winding armature coil for generating rotating magnetic fields, having a same polarity spatially and temporally, is applied in each of the slots.

5. The DC-excited synchronous electric motor according to claim 2, wherein
the armature includes an annular core having a square cross section, the annular core is provided with slots, to which an armature coil is applied, along a circumferential direction at a predetermined interval, an armature tooth is formed between adjacent slots, the armature tooth including an outer diameter surface and both side surfaces of the annular core and being in a sectorial shape in which a circumferential width is increased gradually towards radially outside, and a concentrated winding armature coil is wound along respective peripheries of the outer diameter surface and the both side surfaces of the armature tooth in each of the slots, the concentrated winding armature coil generating rotating magnetic fields having a same polarity spatially and temporally.
